(19) United States
(12) Patent Application Publication
(10) Pub. No.: US 2015/0287140 A1
(43) Pub. Date: Oct. 8, 2015

(54) SYSTEMS AND METHODS FOR COLLATERAL MANAGEMENT

(71) Applicant: JPMORGAN CHASE BANK, N.A., NEW YORK, NY (US)

(72) Inventors: Tianyu Wang, Roswell, GA (US); Ryan Eiler, Holland, PA (US); Kenneth Nuttall, Wilmington, DE (US); Brian Daniel Goodman, Westport, CT (US); Partha Kanjilal, Fairfield, CT (US); Alexander Berson, Dayton, NJ (US); Liran Benjamin Tzadik, Larchmont, NY (US); Gene Fernandez, Holmdel, NJ (US)

(73) Assignee: JPMORGAN CHASE BANK, N.A., NEW YORK, NY (US)

(21) Appl. No.: 14/243,536

(22) Filed: Apr. 2, 2014

(51) Int. Cl. G06Q 40/06

(52) U.S. Cl. CPC G06Q 40/06

(57) ABSTRACT

Computer-based systems and methods have been developed wherein at least one embodiment is capable of automatically determining the optimal collateral holdings in compliance with Credit Support Annex (CSA) agreements, and dynamically reallocating the collateral holdings as time progresses, in order to maintain the optimality of the portfolio of holdings through Customer Service Representatives' (CSR) operations. The optimal allocation may be defined as one that minimizes the operational cost of satisfying CSA agreements via collateral postings. Data may be stored concerning attributes of the components of the holdings of the counterparties, available inventory of assets (securities and cash), current market factors (e.g., interest rates, LIBOR), which are constantly updated. A discrete optimization routine may be used to generate feasible global optimal solutions to allocate and/or reallocate the collateral postings satisfying the operational constraints.

### CROSS-REFERENCE TO RELATED APPLICATIONS

The present application is related to the following commonly-owned patent applications: (a) U.S. application Ser. No. 12/533,263, filed Jul. 31, 2009, entitled “Rehypothecation System and Method”; (b) U.S. application Ser. No. 12/715,532, filed Mar. 3, 2010, entitled “Collateral Management System and Method”; and (c) U.S. application Ser. No. 13/018,528, filed Feb. 1, 2011, entitled “Auto Substitution Collateral Management System and Method.” Each of these related applications is incorporated herein by reference in its entirety.

### FIELD OF THE INVENTION

The present invention relates generally to financial processing and asset management, and more particularly, to systems and methods for managing collateral assets and preferably optimizing a portfolio of collateral holdings for a financial institution.

### BACKGROUND OF THE INVENTION

A financial institution, such as an investment bank, often manages a massive portfolio of collateral assets for derivative trades and has to comply with collateral requirements according to a large number of Credit Support Annex (CSA) agreements. CSA agreements dictate the type and amount of assets that can be posted to or received from each counterparty as collateral. As market conditions change, mark-to-market (MTM) values of the derivative trade positions fluctuate on a daily basis, resulting in a need for the bank to either post or receive additional collateral assets. The bank may also find it desirable to substitute one piece of existing collateral with another. Theoretically, with respect to collateral postings and substitutions, the bank has at least some discretion as to which asset(s) to post as collateral and which collateral asset(s) to substitute (and to replace with what other asset(s)). Such discretion has not been fully utilized by the financial institutions who need to post and/or substitute collaterals regularly on a large scale.

Typically, financial institutions have been making collateral posting and substitution decisions in an ad hoc (and piecemeal) fashion. The decision on collateral posting and/or substitution was often limited to each individual piece of collateral and the compliance with the corresponding CSA for a specific counterparty. While it might be acceptable for a small portfolio with up to a few million dollars' worth of collateral assets, the prior approach is inefficient for a large portfolio with collateral assets worth billions of dollars.

Following the large dealer banks' adoption of a differential discounting framework to more accurately reflect their cost of funding, the terms of CSAs and the assets they allow to be posted as collateral can have a significant impact on the valuation of large derivatives portfolios. Especially as government regulators now require banks to hold a higher level of capital reserve, it has become necessary for each bank to pay more attention to its asset holdings including collateral portfolios.

Other problems and drawbacks also exist.

### SUMMARY OF THE INVENTION

Accordingly, it is one object of the present invention to overcome one or more of the aforementioned and other limitations of existing systems and methods for collateral postings and substitutions by providing techniques which enable more efficient management of collateral assets to achieve more optimal holdings of such assets.

It is another object of the invention to systematically identify opportunities for a financial institution to increase its liquidity capital ratio by allocating and reallocating portions of its collateral portfolio to counterparties. Embodiments of the invention may generate explicit instructions for responsible operators, such as Customer Service Representatives, to realize such opportunities.

The present invention may be mainly embodied in an improved Collateral Management System (CMS) or Collateral Optimization System (COS), which is a computer-based tool to automatically determine collateral requirements in compliance with one or more Credit Support Annex (CSA) agreements and dynamically reallocate collateral holdings, as needed, based on the type of collateral assets available while taking into consideration operational constraints.

According to one particular embodiment, an exemplary method for collateral management may comprise the steps of: storing, on at least one computer-readable storage medium, data associated with a portfolio of collateral assets posted in connection with a plurality of contracts, said data further including collateral requirements for each of the plurality of contracts; storing, on the at least one computer-readable storage medium, valuation data associated with a plurality of assets available for collateral postings or substitutions; establishing, by at least one computer processor, a linear discrete function of a quantified financial return from one or more hypothetical postings and/or substitutions in said portfolio of collateral assets, the one or more hypothetical postings and/or substitutions being based on said valuation data and complying with said collateral requirements for each of said plurality of contracts; generating, by the at least one computer processor, a list of collateral operations with said plurality of available assets, by resolving, within at least one operational constraint, said linear discrete function to maximize or increase said quantified financial return; and outputting said list of collateral operations as instructions, for a human operator or a computer system, to adjust said portfolio of collateral assets.

According to another particular embodiment, an exemplary system for collateral management may comprise: a data management module that manages data associated with a portfolio of collateral assets posted in connection with a plurality of contracts and valuation data associated with a plurality of assets available for collateral postings or substitutions; a contract parsing module that identifies collateral requirements for each of the plurality of contracts; an optimization formulation module that establishes a linear discrete function of a quantified financial return from one or more hypothetical postings and/or substitutions in said portfolio of collateral assets, the one or more hypothetical postings and/or substitutions being based on said valuation data and complying with said collateral requirements for each of said plurality of contracts; a solution module that generates a list of collateral operations with said plurality of available assets, by resolving, within at least one operational constraint, said linear discrete function to maximize or increase said quantified financial return; and an output module that outputs said list of collateral operations as instructions, for a human operator or a computer system, to adjust said portfolio of collateral assets.

One technical effect of the invention is to provide computerized systems and methods for collateral management that allow automated determination of a desired or optimal portfolio of collateral holdings and steps for achieving such a portfolio status within contractual, financial, and/or operational constraints.

Another technical effect of the invention is to facilitate more efficient and effective collaboration among different users on the management of relatively large collateral asset portfolios.

The accompanying drawings are included to provide a further understanding of the invention and are incorporated in, and constitute a part of, this specification. These exemplary drawings illustrate several embodiments of the invention and, together with the description, serve to explain the principles of the invention. Additional features and advantages of the invention will be set forth in the description that follows, and in part will be apparent from the description, or may be learned by practice of the invention.

### BRIEF DESCRIPTION OF THE DRAWINGS

The purpose and advantages of the present invention will be apparent to those of skill in the art from the following detailed description in conjunction with the appended drawings in which like reference characters are used to indicate like elements.

FIG. 1 is a flowchart illustrating an exemplary method for managing and adjusting a portfolio of collateral assets according to one embodiment of the invention.

FIG. 2 is a block diagram illustrating an exemplary system for managing collateral assets according to one embodiment of the invention.

FIG. 3 is a block diagram illustrating exemplary functional modules for managing collateral assets according to one embodiment of the invention.

FIG. 4 is a diagram illustrating exemplary collateral operations according to one embodiment of the invention.

FIG. 5 shows an exemplary output display of a collateral optimization run in accordance with an embodiment of the present invention.

FIG. 6 shows a flowchart illustrating another exemplary method for managing and adjusting a portfolio of collateral assets according to one embodiment of the invention.

### DETAILED DESCRIPTION OF THE INVENTION

The present invention is generally directed to systems and methods for managing collateral assets and preferably optimizing a portfolio of collateral holdings for a financial institution. Embodiments of the present invention take a holistic approach towards the management of collateral postings and substitutions. A computer-based system has been developed, which is capable of automatically determining the optimal collateral holdings in compliance with CSA agreements (as well as within financial and/or operational constraints) and dynamically reallocating the collateral holdings as time progresses. Embodiments of the invention can increase a financial institution's liquidity capital ratio by allocating and reallocating portions of its collateral portfolio to counterparties based on an optimization model. The output of the model provides explicit instructions to responsible Customer Service Representatives to execute such collateral operations.

More specifically, a linear discrete model may be formulated which looks at an overall portfolio of collateral assets in light of all the collateral eligibilities across all counterparties and tries to achieve the best collateral portfolio (e.g., highest net interest at end of the day and/or end of the year) by making a number of collateral substitutions and meeting daily margin calls in the most efficient way. In addition to asset valuation and CSA obligations, the linear program optimizes collateral operations in accordance with a number of operational constraints, such as the number of substitutions and finance desk moves that can be made per week, total number and size of the asset pieces that can be posted, regulatory requirements, and so on. Based on the model, a multi-threaded optimization solver may sweep out a 2-dimensional grid of constraints based on the number of substitution and the number of finance desk moves, generating optimal or most feasible solutions. Then, using a ranking logic, a list of solutions may be ranked for collateral postings and substitutions, and specific instructions may be provided to a group of CSRs (or a technology system) to execute the solutions.

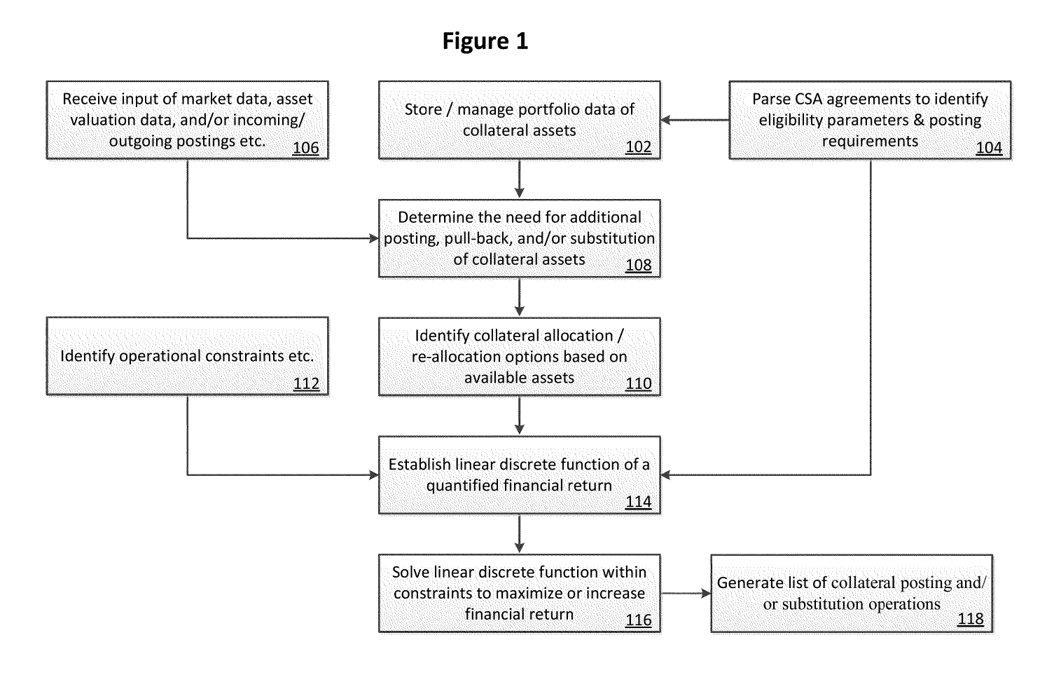

FIG. 1 is a flowchart illustrating an exemplary method for managing and adjusting a portfolio of collateral assets according to one embodiment of the invention.

In Step 102, data associated with a portfolio of collateral assets may be stored and managed in a database. The collateral assets may have been posted in connection with a plurality of contracts. For example, for each derivative trade, there may be a legal document referred to as Credit Support Annex (CSA) agreement that regulates collateral posting for that particular transaction. In the database, each piece of collateral asset may be associated with a specific CSA, and data of collateral assets associated with each CSA may be grouped or correlated together. One specific embodiment of the present invention employs MongoDB, an open-source/proprietary (www.mongodb.com) NoSQL database, although other types of databases could be used.

In Step 104, the CSA agreements (and/or other contracts or legal documents) governing the portfolio of collateral assets may be parsed to identify collateral requirements therein.

Each CSA defines the terms or rules under which collateral is posted or transferred between counterparties to mitigate the credit risk arising from their respective derivative positions. For example, the CSA may specify what types and amount of assets are eligible as collateral in that transaction and how much haircut is applied to an asset. A haircut is a percentage that is subtracted from the market value of a piece of collateral asset. The size of the haircut reflects the perceived risk associated with holding that asset. The CSA may also include collateral posting requirements such as a minimum size of an asset and a total number of distinct asset pieces that are permitted as collateral.

While they certainly can be identified and entered into the database manually, these specific collateral requirements may preferably be determined by automatically parsing the CSA agreements. According to one particular embodiment, a CSA preprocessing and segmentation procedure could be implemented on the 10-20% CSAs that account for 80-90% of postings and only focus on those having the most economic impact. The CSAs may be segmented based on size, risks (e.g., risks of call-back/rejection by counterparty), and historical moves of portfolio. The collateral requirements data of at least some of the CSA agreements may be stored in connection with the data of the collateral portfolio.

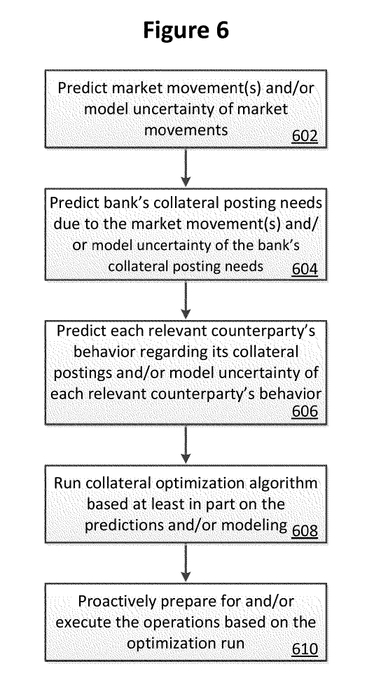

In Step 106, an input of market data, asset valuation data, and/or incoming/outgoing postings may be received. For example, the input data may include market changes in currency exchange rates, stock share prices, bond interest rates, and major indexes or benchmarks. Depending on the operational needs for collateral management and optimization, the data input may be received via a real-time data feed or through one or more batch downloads from various data sources. The input data may also indicate what assets are expected to be posted out or pulled back, thereby more accurately reflecting the state of the collateral portfolio currently and in the near future. The valuation of assets (and the amount of discount applied to asset values) may be determined based on various factors such as market prices, liquidity, general demand/desirability, and party agreements, etc. For example, less desirable asset types may receive a lower level of value assessment or produce less economic benefit for the bank. According to some embodiments of the present invention, predictive modeling may be used to anticipate future market movements and counterparty behavior, and the predictions may be used as inputs for the collateral optimization analysis to forecast asset allocation/reallocation moves, as described in more detail in connection with FIG. 6.

Based on the input data as well as the collateral requirements data, it may be determined in Step 108 the need for any additional posting, pull-back, and/or substitution of collateral assets. Daily mark-to-market fluctuation could cause a bank's position to be out-of-the-money by a certain amount and the bank may have to meet margin call by posting additional collateral. Collateral assets already posted to a counterparty may also be substituted with other compliant assets (e.g., replace USD cash with EURO cash). Such high-level needs for collateral operations may be identified in view of the current composition and valuation of the collateral portfolio.

In Step 110, collateral allocation and/or re-allocation options may be identified based on available assets. The bank's available inventory of assets may include various currencies and securities such as USD cash, USD treasury, and EURO cash etc. Based on the values and availability of these assets, there may be a number of ways to change the composition of the collateral portfolio by allocating and/or re-allocating assets under the respective CSA agreements.

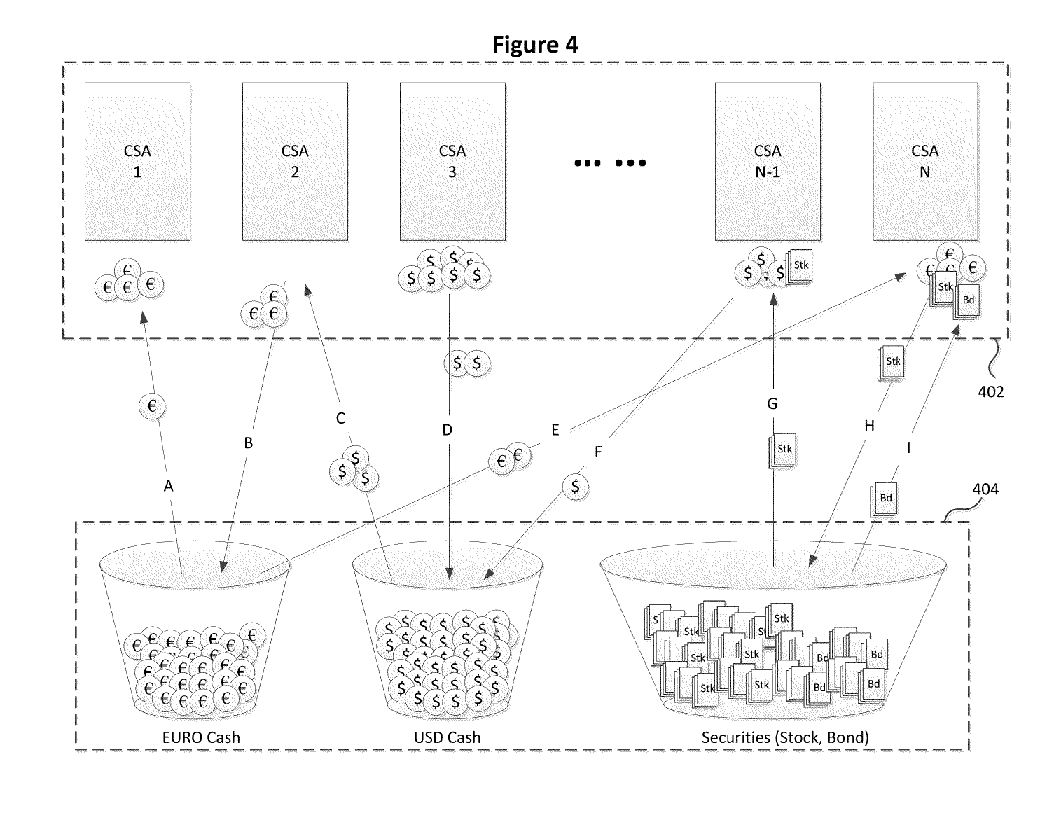

Referring to FIG. 4, there is shown a diagram illustrating exemplary collateral operations where a collateral portfolio 402 holds assets pursuant to a number of CSA agreements (CSA 1, CSA 2, . . . CSA N) and where an inventory of available assets 404 are represented by a number of asset buckets corresponding to different asset types (EURO Cash, USD Cash, and Securities). The arrows between the portfolio 402 and the inventory 404 represent various collateral allocation and re-allocation options that could be potentially performed to adjust the composition of the collateral portfolio 402. For example, the collateral under CSA 1 may have been posted with EURO cash; a change in the bank's trade position related to CSA 1 or currency exchange rate may require that a certain amount of additional collateral be posted in EUROs (hence the operation “A”). Similarly, market changes or the bank's own preferences may require the EURO cash collateral previously posted under CSA 2 be swapped with USD cash (hence the operations “B” and “C”). The collateral under CSA 3 may become more than what is contractually required due to appreciation of USD and the surplus could be pulled back (hence the operation “D”). Similar posting and pullback operations (e.g., operations “E” through “I”) may be applied to collaterals which include securities or a mixture of currency and security assets (e.g., under CSA N−1 and CSA N). For convenience of description and illustration, the collateral assets posted under CSA K may be referred to simply as “CSA K.”

In Step 112, one or more operational constraints (and/or any other constraint) may be identified. Since any desired adjustment to a collateral portfolio requires collateral operations carried out by the bank's personnel and/or computer system, the performance of such operations are subject to various practical limitations such as the total number of substitutions and/or finance desk moves (lending/borrowing of a security) that can be completed within a predefined time period and/or at a reasonable cost. Other constraints may include any regulatory constraint on financial transactions involved in the contemplated collateral operations, such as repurchase agreements or “repos.”

In Step 114, a linear discrete function of a quantified financial return (or objective function) may be established. The financial return may be any quantifiable financial benefit related to or impacted by the portfolio of collateral assets. According to one embodiment of the present invention, the objective function may be a sum of each contemplated collateral posting times its return rates (interest). Alternatively, the linear discrete function may quantify costs instead of benefits. For example, according to another embodiment, the objective function may be the total costs of all the contemplated collateral operations such as the costs of funding or borrowing and transactional or administrative costs. This mathematical model may factor in, or be subject to, some or all of the operational, regulatory, and/or financial constraints.

In Step 116, the linear discrete function may be solved within the various constraints to maximize or increase financial return from the contemplated collateral allocation or re-allocation operations (or to minimize or decrease financial costs thereof). According to one specific embodiment of the present invention, an open-source optimization solver called Symphony may be employed to solve the objective function although other solver such as LP Solve could also be utilized.

In Step 118, a list of collateral posting and/or substitution operations may be generated based on the solution of the objective function. The solution may be rendered in a graphical user interface (GUI) and/or in daily/weekly reports. The solution may, within the operational constraints etc., provide a clear guidance as to which collateral operations to perform. Accordingly, instructions may be generated for execution by human operators and/or computers.

According to one particular embodiment of the present invention, a linear discrete program may be utilized in the global optimization of a financial institution's collateral portfolio where the formulation may involve maximizing a linear objective function subject to a mix of continuous and discrete constraints. As one specific example, the formulation may seek to maximize the following objective function:

$${\sum }_{i = 1}^{{N}_{CSA}} ( {\sum }_{j = 1}^{{N}_{sec}} ( {r}_{i , j} {p}_{i , j} + {r}_{i , j}^{′} {p}_{i , j}^{′} + {r}_{i , j}^{″} {p}_{i , j}^{″} ) + {\sum }_{k = 1}^{{N}_{cash}} {r}_{i , k} {p}_{i , k} )$$

where i=1, 2, 3, . . . , N_{CSA}, j=1, 2, 3, . . . , N_{sec}, k=1, 2, 3 . . . , N_{cash}. A detailed listing of variable definitions in this function is provided below:

r_{i,j}: rate of return of re-hypothecating security j to CSA i ([0,1])

h_{i,j}: CSA-specific haircut for rehypothecating collateral j to CSA i ([0,1])

p_{i,j}: quantity of security j rehypothecated to CSA (≦min (μⱼ, Pᵢ))

r′_{i,j}: rate of return of posting cash to CSA i by repoing security j ([0,1])

h′_{i,j}: CSA-specific haircut for repoing security j for cash to post to CSA i ([0,1])

p′_{i,j}: quantity of cash posted to post to CSA i via repoing security i

r″_{i,j}: rate of return of posting security j to CSA i ([0,1]) via borrowing

h″_{i,j}: CSA-specific haircut for CSA i and security j ([0,1]) via borrowing

p″_{i,j}: quantity of security j posted to CSA i via borrowing

r_{i,k}: rate of return of posting cash of currency type k to CSA i ([0,1])

h_{i,k}: CSA-specific haircut for posting cash of currency type k directly to CSA i

p_{i,k}: quantity of cash of currency type k to post to CSA i

Pᵢ: total quantity of collateral owed to CSA i (≧0)

μⱼ: total amount of security j in available for use in optimization (≧0)

The objective function is maximized subject to a variety of operational constraints that are described below wherein related variables of these constraints are also defined.

One exemplary constraint is Individual CSA Agreement Amount Constraint which dictates that each CSA's call amount must be met exactly:

$${\sum }_{j = 1}^{{N}_{sec}} ( {h}_{i , j} {p}_{i , j} + {h}_{i , j}^{′} {p}_{i , j}^{′} + {h}_{i , j}^{″} {p}_{i , j}^{″} ) + {\sum }_{k = 1}^{{N}_{cash}} {h}_{i , k} {p}_{i , k} = {P}_{i} , ∀ i$$

Another exemplary constraint is Inventory Constraints which dictates that the amount of each security in inventory utilized in optimizing the collateral portfolio must not exceed a set threshold:

$${γ}_{j} \leq {\sum }_{i = 1}^{{N}_{CSA}} {\sum }_{j = 1}^{{N}_{sec}} ( {p}_{i , j} + {p}_{i , j}^{′} ) \leq {μ}_{j} , ∀ j$$

Here, μⱼ corresponds to the maximum amount of a security j that can be utilized in optimization of the portfolio. Values of μⱼ are specified by the business user and are typically percentages of the total amount in inventory (e.g., 90% of total inventory).

Other exemplary constraint may include CSA-level constraints for (a) Enforcing Minimum Piece Size Constraints for Posting Collateral, which dictates the smallest amount of a single collateral type posted to a CSA cannot be below specified threshold(s), and (b) CSA-level Maximum Piece Count, which dictates the total number of distinct collateral types posted to a CSA cannot exceed a specified threshold count, as expressed mathematically below. For each CSA i and a corresponding eligible security j,

p_{i,j}+p″_{i,j}−(Pᵢ+δ)t_{min,i,j}≦0

p_{i,j}+p″_{i,j}−mᵢt_{min,i,j}≧0

Similarly, for both direct cash postings and cash postings obtained from repo trades of a currency k,

$${\sum }_{j = 1}^{{N}_{repo , k}} {p}_{i , j}^{′} + {p}_{i , k} - ( {P}_{i} + δ ) {t}_{min , i , k} \leq 0$$

$${\sum }_{j = 1}^{{N}_{repo , k}} {p}_{i , j}^{′} + {p}_{i , k} - {m}_{i} {t}_{min , i , k} \leq 0$$

Here, δ is a tolerance value (e.g., 0.1% of Pᵢ) and mᵢ is the minimum size allowed to post to CSA i as dictated by a business user. t_{min,i,j} and t_{min,i,k} are binary indicator variables for posting security j to CSA i and currency (cash) k to CSA i. N_{repo,k} represents the total number of securities that are eligible for a repo trade to generate cash of currency k.

In addition to individual posting constraints on minimum size, a CSA-level constraint may also be imposed to limit the total number of collateral pieces that are posted to the CSA itself. Specifically, for CSA i and using all t_{min,i,j} and t_{min,i,k},

$${\sum }_{k = 1}^{{N}_{cash , i}} {t}_{min , i , k} + {\sum }_{j = 1}^{{N}_{sec , i}} {t}_{min , i , j} \leq {M}_{i}$$

where N_{cash,i} is the total number of currencies that CSA i is eligible for and similarly N_{sec,i} is the total number of securities that CSA i is eligible for. Mᵢ is a non-zero integer representing the maximum number of collateral pieces allowed to be posted to CSA i as determined by a business user.

Further exemplary constraints may include CSA-level constraints for Counting Substitutions. For a CSA, a substitution is defined as when an existing posted collateral type is either reduced or increased. A substitution is also defined as when a collateral type that was not posted to the CSA is posted to the CSA (as recommended by the optimization solution). If CSA i has a security j posted to it in its existing configuration (prior to optimization), then the following constraints may be imposed:

p_{i,j}+p″_{i,j}+p_{o,i,j}t_{i,j},−≧p_{o,i,j}−δ

p_{i,j}+p″_{i,j}−(Pᵢ+δ)t_{i,j,+}p_{o,i,j}+δ

Otherwise, if CSA i does not have security j posted to it in its existing configuration (prior to optimization), then the following constraints may be imposed:

p_{i,j}+p″_{i,j}−(Pᵢ+δ)t_{i,j,0}≦δ

Here, δ is a tolerance (e.g., 0.1% of Pᵢ) and p_{o,i,j} is the amount of j currently posted to CSA tᵢ, t_{i,j,-}, t_{i,j,+}, and t_{i,j,0} are binary indicator variables. t_{i,j,-} and t_{i,j,+} indicate when the proposed posting amount (from the optimization routine) of security j to CSA i is less than or greater than the amount currently posted to within δ. t_{i,j,0} indicates when the amount proposed exceeds the tolerance δ. The latter constraint is added for all securities for which CSA i is eligible.

An analogous set of constraints may also be added for each eligible currency, i.e., for an existing cash posting of currency k of CSA

$${\sum }_{j = 1}^{{N}_{repo , k}} {p}_{i , j}^{′} + {p}_{i , k} - {p}_{0 , i , k} {t}_{i , k , -} \geq {p}_{0 , i , k} - δ$$

$${\sum }_{j = 1}^{{N}_{repo , k}} {p}_{i , j}^{′} + {p}_{i , k} - ( {P}_{i} + δ ) {p}_{0 , i , k} {t}_{i , k , +} \leq {p}_{0 , i , k} + δ$$

and for a currency k not currently posted to CSA

$${\sum }_{j = 1}^{{N}_{repo , k}} {p}_{i , j}^{′} + {p}_{i , k} - ( {P}_{i} + δ ) {t}_{i , k , 0} \leq δ$$

where p_{o,i,k} is the amount of cash in currency k currently posted to CSA i and N_{repo,k} is the total number of securities that are eligible for a repo trade to generate cash of currency k.

Yet further exemplary constraints may include global constraints, such as (a) Global Constraints for Counting Finance Desk Moves and (b) Global Substitution and Finance Desk Move Constraints.

As to the Global Constraints for Counting Finance Desk Moves, a financial desk move is defined as when a security is repurchased to generate cash or borrow a security. For repo finance desk moves, the following constraints may be applied:

$${\sum }_{i = 1}^{{N}_{CSA}} {p}_{i , j}^{′} - {μ}_{j} {t}_{r , j} \leq δ ∀ j$$

Similarly, for securities j that are not currently borrowed (as determined by a predefined list from the business user),

$${\sum }_{i = 1}^{{N}_{CSA}} {p}_{i , j}^{″} - {B}_{j} {t}_{b , j} \leq δ ∀ j where j is not currently borrowed$$

Here, Bⱼ corresponds to a business-user defined limit on the amount to borrow of a particulary security. t_{r,j} and t_{b,j} are binary indicator variables that indicate the existence of a repo or borrow finance desk move, respectively.

As to the Global Substitution and Finance Desk Move Constraints, they may require that the total number of substitutions and finance desk moves cannot exceed certain thresholds. For substitutions, a sum may be generated across all CSA's their respective substitution indicator variables:

$${\sum }_{i = 1}^{{N}_{csa}} [ {\sum }_{j = 1}^{{N}_{sec}} ( {v}_{1} ( {t}_{i , j , -} + {t}_{i , j , +} ) + {v}_{2} {t}_{i , j , 0} ) + {\sum }_{k = 1}^{{N}_{cash}} ( {v}_{3} ( {t}_{i , k , -} + {t}_{i , k , +} ) + {v}_{4} {t}_{i , k , 0} ) ] \leq {T}_{s}$$

For ease of notation only, v₁ and v₂ are denoted as binary indicator variables indicating the presence or absence of a security j posted to CSA i. Similarly, v₃ and v₄ are binary indicator variables indicating the presence of absence of cash of currency k posted to CSA i. Here, T_{S} corresponds to a non-zero integer value representing the total number of substitutions allowed as defined by a business user. Similarly, for finance desk moves,

$${\sum }_{j = 1}^{{N}_{sec}} {t}_{r , j} + {\sum }_{j 2 = 1}^{{N}_{borrow}} {t}_{b , j} \leq {T}_{B}$$

Here, N_{sec} is the number of securites that can be repurchased to obtain cash (across all currencies). T_{B} is the total number of possible borrowed security types as defined by a business user.

Those skilled in the art should appreciate that the above-described formulation is just an exemplary implementation according to a particular embodiment of the present invention. It should be noted that at least some modest variations of the exemplary formulation, such as relaxations of one or more of the constraints noted above, may be implemented without deviating from the methodology of addressing collateral optimization described herein. For instance, removing all substitution and finance desk move constraints may be warranted in the future when technology can significantly reduce the operational overhead needed to obtain an optimal portfolio.

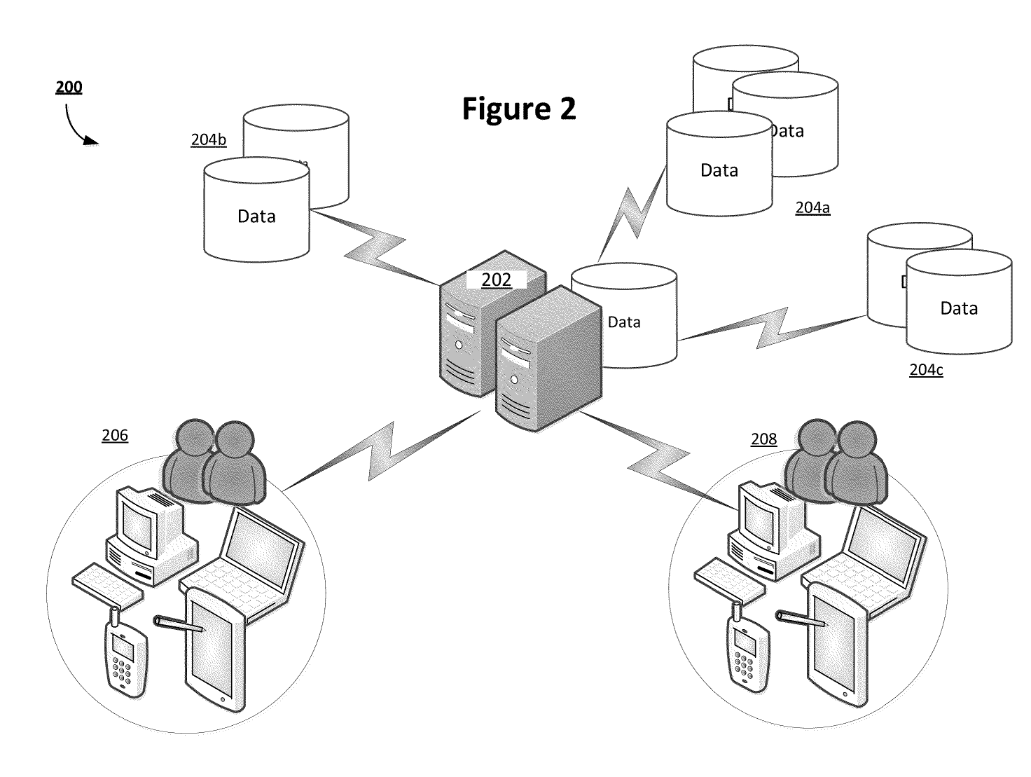

FIG. 2 is a block diagram illustrating an exemplary system 200 for managing collateral assets according to one embodiment of the invention.

As shown, the system 200 (and related software) is implemented based on computing equipment. Generally, it should be noted that the components depicted and described herein may be, or include, a computer or multiple computers. Although the components are sometimes shown as discrete units, they may be interconnected or combined. The components may be described in the general context of computer-executable instructions, such as program modules, being executed by a computer. Generally, program modules include routines, programs, objects, applications, components, data structures, etc., that perform particular tasks or implement particular abstract data types. For example, a server may comprise a single server or a group of servers used to service users. Additionally, a server may comprise a front-end web server and a back-end database server. Alternatively, those functions can be integrated into a single server device.

Those skilled in the art will appreciate that the invention may be practiced with various computer system configurations, including hand-held wireless devices such as mobile phones, tablets or PDAs, multiprocessor systems, microprocessor-based or programmable consumer electronics, minicomputers, mainframe computers, and the like. The invention may also be practiced in distributed computing environments where tasks are performed by remote processing devices that are linked through a communications network. In a distributed computing environment, program modules may be located in both local and remote computer storage media including memory storage devices.

Computing devices (e.g., mobile devices, lap-tops, desk-tops, etc.) typically include a variety of computer readable media that can form part of the system memory and be read by the processing unit. By way of example, and not limitation, computer readable media may comprise computer storage media and communication media. The system memory may include computer storage media in the form of volatile and/or nonvolatile memory such as read only memory (ROM) and random access memory (RAM). A basic input/output system (BIOS), containing the basic routines that help to transfer information between elements, such as during start-up, is typically stored in ROM. RAM typically contains data and/or program modules that are immediately accessible to and/or presently being operated on by a processing unit. The data or program modules may include an operating system, application programs, other program modules, and program data. The operating system may be or include a variety of operating systems such as the Macintosh® OS or Apple iOS operating systems, Google Android operating system (and variations thereof), Microsoft Windows® operating system (desktop and/or mobile version), the Unix operating system, the Linux operating system, the Xenix operating system, the IBM AIX™ operating system, the Hewlett Packard UX™ operating system, the Novell Netware™ operating system, the Sun Microsystems Solaris™ operating system, the OS/2™ operating system, the BeOS™ operating system, the Apache™ operating system, an OpenStep™ operating system or another operating system or platform.

User applications may be so-called stand-alone applications executing on user devices or they may be client-server type applications that interface with server-side components. They may include applications provided by the server, such as Java Applets, that may be delivered with web pages.

The memory will include at least one set of instructions that is either permanently or temporarily stored. The processor executes the instructions that are stored in order to process data. The set of instructions may include various instructions that perform a particular task or tasks, such as those shown in the appended flowchart. Such a set of instructions for performing a particular task may be characterized as a program, software program, software, engine, module, component, mechanism, or tool. The computer may include a plurality of software processing modules stored in a memory as described herein and executed on a processor in the manner described herein. The program modules may be in the form of any suitable programming language, which is converted to machine language or object code to allow the processor or processors to read the instructions. That is, written lines of programming code or source code, in a particular programming language, may be converted to machine language using a compiler, assembler, or interpreter. The machine language may be binary coded machine instructions specific to a particular computer.

Any suitable programming language may be used in accordance with the various embodiments of the invention. Illustratively, the programming language used may include assembly language, Ada, APL, Basic, C, C++, COBOL, dBase, Forth, FORTRAN, Java, Modula-2, Pascal, Prolog, RUM and/or JavaScript, for example. Further, it is not necessary that a single type of instruction or programming language be utilized in conjunction with the operation of the system and method of the invention. Rather, any number of different programming languages may be utilized as is necessary or desirable.

In addition, the instructions and/or data used in the practice of the invention may utilize any compression or encryption technique or algorithm, as may be desired. An encryption module might be used to encrypt data. Further, files or other data may be decrypted using a suitable decryption module.

The computing environment may also include other removable/non-removable, volatile/nonvolatile computer storage media. For example, a hard disk drive may read or write to non-removable, nonvolatile magnetic media. A magnetic disk drive may read from or write to a removable, nonvolatile magnetic disk, and an optical disk drive may read from or write to a removable, nonvolatile optical disk such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The storage media is typically connected to the system bus through a removable or non-removable memory interface.

The processing unit that executes commands and instructions may be a general purpose computer, but may utilize any of a wide variety of other technologies including a special purpose computer, a microcomputer, mini-computer, mainframe computer, processor, CPU (Central Processing Unit), programmed micro-processor, micro-controller, peripheral integrated circuit element, a CSIC (Visitor Specific Integrated Circuit), ASIC (Application Specific Integrated Circuit), a logic circuit, a digital signal processor, a programmable logic device such as an FPGA (Field Programmable Gate Array), PLD (Programmable Logic Device), PLA (Programmable Logic Array), RFID processor, smart chip, or any other device or arrangement of devices that is capable of implementing the steps of the processes of the invention.

It is appreciated that in order to practice the invention as described herein, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing as described herein is performed by various components and various memories. However, it is appreciated that the processing performed by two distinct components as described herein may, in accordance with a further embodiment of the invention, be performed by a single component. Further, the processing performed by one distinct component as described herein may be performed by two distinct components. In a similar manner, the memory storage performed by two distinct memory portions as described herein may, in accordance with a further embodiment of the invention, be performed by a single memory portion. Further, the memory storage performed by one distinct memory portion as described herein may be performed by two memory portions, for example.

A user may enter commands and information into the computer through a user interface that includes input devices such as a keyboard and pointing device, commonly referred to as a mouse, trackball or touch pad. Other input devices may include a microphone, joystick, game pad, satellite dish, scanner, voice recognition device, keyboard, touch screen, toggle switch, pushbutton, or the like. Input devices include those that recognize hand movements or gestures, such as in the case of gesture set supported by Android or the swipe movements recognized in iOS-based devices. These and other input devices are often connected to the processing unit through a user input interface that is coupled to the system bus, but may be connected by other interface and bus structures, such as a parallel port, game port or a universal serial bus (USB).

A user interface may include any hardware, software, or combination of hardware and software used by the processing machine that allows a user to interact with the processing machine. A user interface may be in the form of a dialogue screen for example. A user interface may also include any of a mouse, touch screen, keyboard, voice reader, voice recognizer, dialogue screen, menu box, list, checkbox, toggle switch, a pushbutton or other device that allows a user to receive information regarding the operation of the processing machine as it processes a set of instructions and/or provide the processing machine with information. Accordingly, the user interface is any device that provides communication between a user and a processing machine. The information provided by the user to the processing machine through the user interface may be in the form of a command, a selection of data, or some other input, for example.

As discussed herein, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the invention, it is not necessary that a human user actually interact with a user interface used by the processing machine of the invention. Rather, it is also contemplated that the user interface of the invention might interact, i.e., convey and receive information, with another processing machine, rather than a human user. Further, it is contemplated that a user interface utilized in the invention may interact partially with another processing machine or processing machines, while also interacting partially with a human user.

One or more monitors or display devices may also be connected to the system bus via an interface. In addition to display devices, computers may also include other peripheral output devices, which may be connected through an output peripheral interface. The computers implementing the invention may operate in a networked environment using logical connections to one or more remote computers, the remote computers typically including many or all of the elements described herein.

Various networks may be implemented in accordance with embodiments of the invention, including a wired or wireless local area network (LAN) and a wide area network (WAN), the Internet, wireless personal area network (PAN) and other types of networks. When used in a LAN networking environment, computers may be connected to the LAN through a network interface or adapter. When used in a WAN networking environment, computers typically include a modem or other communication mechanism. Modems may be internal or external, and may be connected to the system bus via the user-input interface, or other appropriate mechanism.

Computers may be connected over the Internet, an Intranet, Extranet, Ethernet, or any other system that provides communications. Some suitable communications protocols may include TCP/IP, UDP, or OSI, for example. For wireless communications, communications protocols may include Bluetooth, Zigbee, IrDa, Wi-Fi, 2G, 3G, Ultra-Wideband and Long Term Evolution (LTE) or other suitable protocols. The wireless communications protocol may also include short-range communications devices and protocols, such as RFID, or Near-Field Communication radio transmissions. Furthermore, components of the system may communicate through a combination of wired or wireless paths.

Although many other internal components of the computer are not shown, those of ordinary skill in the art will appreciate that such components and the interconnections are well known. Accordingly, additional details concerning the internal construction of the computer need not be disclosed in connection with the present invention.

Specifically, the system 200 may comprise a collateral management server 202 which is in communication with one or more local and/or remote data sources (204a, 204b, 204c). The collateral management server 202 may be implemented as part of an enterprise application server that is accessible by a number of client computers (206, 208). The server 202 hosts the collateral management and optimization related functions, supports the client interfaces, and provides access to the data sources. For example, the server 202 may receive collateral data from one or more internal databases and keep receiving updates of those databases. The server 202 may also receive market data from an external data source via a continuous data feed or a periodic file feed. The client computers 206 and 208 may each be a networked workstation, laptop computer, tablet computer, or mobile computing device that can securely communicate with the server 202.

In operation, the users may use the client computers 206 and 208 to authenticate themselves to the server 202 before being granted appropriate access to the collateral management functions and related data. The collateral management server 202 may mediate the client access and respond with the proper user interface screens and data. An authorized user may cause input data to be retrieved from their respective data sources and supplied to an optimization model for processing to generate daily/weekly reports and other outputs related to collateral operations. According to some embodiments, the collateral management and optimization methodology need not be implemented in a networked computing environment and could be performed in a standalone computing device as long as the requisite inputs are available.

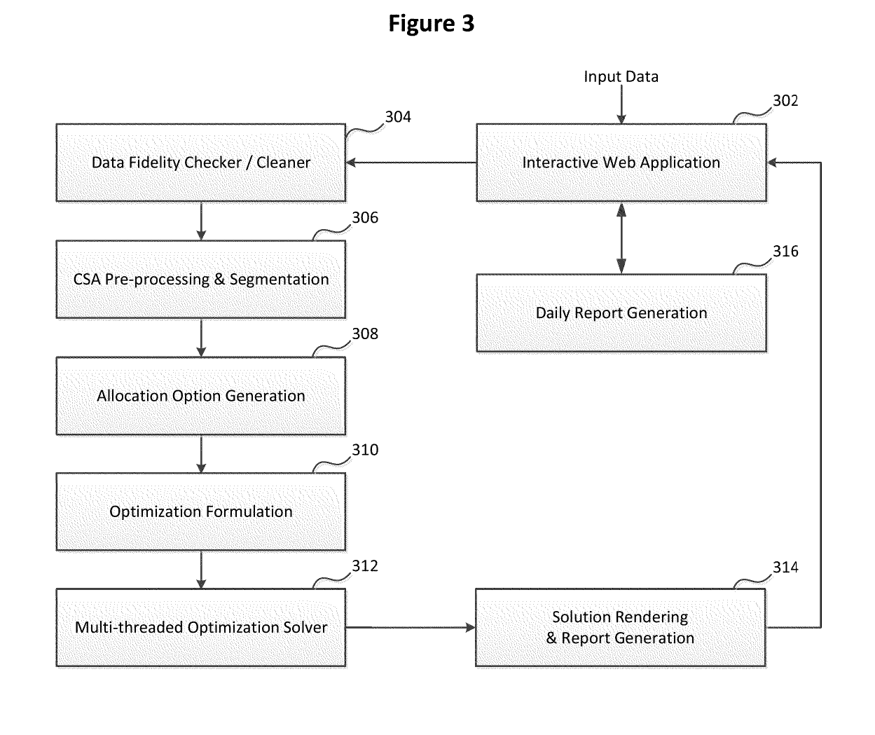

FIG. 3 is a block diagram illustrating exemplary functional modules for managing collateral assets according to one embodiment of the invention, and more particularly for implementing an optimization algorithm to adjust a collateral portfolio. These functional modules may be implemented on computer hardware and/or software components.

An Interactive Web Application 302 may provide the primary GUI for user interaction with the collateral management/optimization functionalities. The Interactive Web Application 302 may be used to receive input data, for example, by uploading data related to incoming collateral postings, outgoing postings, industry and market parameters.

A Data Fidelity Checker/Cleaner 304 may be implemented to verify and sanitize input data which are typically in the form of comma-separated values (CSV). According to one embodiment of the present invention, five set of input data (in CSV files) may be generated on a daily basis to be consumed by the optimization algorithm: Collateral Requirement, Eligibility, Postings, Postings Total, and Repo Borrows. These input files may contain the necessary data required to detail the current state of a collateral portfolio and repo activities, the legally eligible assets under each CSA, and the amount of collateral due to be posted/received on a daily basis. These files are further processed upon receipt in order to properly format and reconfigure the data for the optimization algorithm.

A CSA Pre-processing & Segmentation module 306 is responsible for identifying and selecting the most relevant CSA agreements and parsing their respective collateral requirements. According to some embodiments, a majority of the CSAs may have minimal aggregate impact on the collateral optimization objective; therefore the optimization algorithm may be restricted to a subset of the largest CSAs (e.g., ranked by required collateral MTM amount). Accordingly, a current methodology creates a file that includes the CSAs which, when aggregated, account for a specified percentage (e.g., 80%-95%) of the overall collateral requirement MTM amount. This percentage may be adjusted as needed, and can have a considerable impact on computation time needed for the optimization. According to one embodiment, the input Requirements file may be modified by appending additional rows in order to keep a correct running track of dropped (discarded) CSAs. In addition, new segment files may be generated to provide a mapping of each CSA ID to a binary flag denoting whether this CSA should be considered in a weekly optimization run.

An Allocation Option Generation module 308 may evaluate available inventory of assets and determine which allocation or re-allocation operations could be potentially performed to adjust an existing portfolio of collateral assets. For example, each piece of collateral eligible under each CSA may be assigned a return value by the algorithm, which could be derived from market data and/or manual parameters.

According to one embodiment of the present invention, a matrix comprised of “return rates” (USD-equivalent rate of return) may be populated for each eligible piece of collateral asset. This rate is a function of: market-derived LIBOR rates (LIBOR stands for London Interbank Offered Rate), LIBOR/OIS basis spreads (OIS stands for “overnight indexed swap” and OIS rate refers to the index rate for overnight unsecured lending between banks), cross-currency basis spreads, repo rates, and internal funding adjustments. In one particular approach, internally published CSA spreads, which are an aggregation of LIBOR/OIS spreads and cross-currency basis spreads, may be used. These are used to reduce the number of inputs to the solver. Based on the assumption of a one-month funding horizon, all the market data referenced in the calculations can be of a one-month tenor.

The valuation may start with the simplest case which is a straight cash posting. To arrive at an “all-in” return rate for a given currency, the CSA spread for that currency may be added to the three-month LIBOR USD rate. To evaluate non-cash assets, additional adjustments may be made to this cash rate to compensate for OIS/repo relative value, transactional costs, and funding implications.

Some exemplary computations for each collateral option are outlined below (values are in basis point or by unless otherwise stated and “(ccy)” denotes a dependency on the relevant currency):
Cash Rate (ccy): 3m LIBOR USD+CSA Spread (ccy)+CSA-defined rate adjustment (if applicable)
Rehypothecate Securities: Cash rate (ccy)+[(IBT funding rate)/(Pledgee haircut on asset)]
Repo Securities: Cash rate (ccy)+[(IBT funding rate)/(Pledgee haircut on asset)]+[OIS (ccy)−Repo (ccy)]
Reverse Repo Securities: Cash rate (ccy)−[(FDIC fee)/(Pledgee haircut on asset)]+[Reverse Repo (ccy)−OIS (ccy)]
   Only the options which are relevant to the CSA based on its collateral eligibility are considered. To arrive at a net interest income figure, these return rates for each respective collateral option may be multiplied by the USD amount of collateral required to be posted (non-haircut adjusted).

An Optimization Formulation module 310 may be used to establish an optimization model comprising an objective function of financial returns or costs. As described above, by taking into account the specifications and interrelated attributes of each CSA, as well as operational constraints and current state of the collateral portfolio, the mathematical model may be used to approach the task of posting collateral optimally as an integer linear programming problem.

A Multi-threaded Optimization Solver 312 may then be run to solve the objective function, for example, by seeking or approaching the maximum of a financial return or the minimum of a financial cost.

In addition to the input files described above, several other files may be used to set solver parameters, value collateral assets, and manage the solver algorithm used in the optimization. For example, an asset_level_params.csv file may specify, for each country/asset type combination, the ability to repo the asset to the finance desk, the ability to borrow the asset from the finance desk, the haircut taken by the finance desk, whether the asset is eligible to be posted out as collateral, and the amount of the asset in inventory to hold reserve as a MTM variation buffer. A collat_size_constraint.csv file may specify the minimum size of each collateral piece allowed to be posted to a counterparty which is a function of size of the call amount. A credit_ratings.csv file may provide a ranked listing of all credit ratings to be referenced in collateral source files. A csa_spreads.csv file may provide CSA spread levels for each applicable currency which account for LIBOR/OIS and cross-currency basis spreads. A fragment_constraint.csv file may specify the maximum number of pieces of collateral allowed to be posted to a counterparty which is also a function of the size of the call amount. An ois_rates.csv file may provide baseline OIS rates in each applicable currency, used to compute the OIS/Repo basis, which may be sourced from Reuters. A repo_rates.csv file may provide baseline repo rates in each applicable currency, used to compute the OIS/Repo basis, which may be sourced from Reuters and/or other internal or external sources. A single_params.csv file may provide an internal IBT funding rate and FDIC fee to be applied when valuing security re-hypothecation and security borrows. (The IBT funding rate is an internally defined charge leveraged upon the trading desks as a consequence of holding unused securities on the bank's balance sheet. The FDIC fee is a charge arising from borrowing (“reversing-in”) securities in the open market.) A spread_to_ois.csv file may provide adjustments to the cash rate for the listed CSAs.

Once all input files are uploaded to the solver, an optimization run may be scheduled to run, for example, for a user-specified maximum amount of time.

After a full optimization run has completed, a comprehensive “target” portfolio for all of the relevant CSAs may be generated, which improves the economics of the collateral portfolio within the limitations of what is operationally feasible. These results may suggest partial and/or full substitutions of the collateral assets currently residing with various counterparties, and these substitutions may take several days to complete for operational reasons. Additionally, the day-to-day operations may require exchange of collateral due to trading and market activity, and this provides an opportunity to incrementally refine the portfolio on a daily basis.

The results from the Multi-threaded Optimization Solver 312 may be rendered by a Solution Rendering & Report Generation module 314 for displaying via a GUI by the Interactive Web Application 302.

As the optimization runs complete and/or times out, the lattice in the GUI window will be populated with each result and labeled with a number which represents the net interest income benefit (in $USD mm) of the portfolio if all proposed substitutions are executed. This pickup in interest accrual is on an annualized basis and is relative to the “baseline,” or existing portfolio. The baseline portfolio assumes, given the existing portfolio configuration, that the securities currently available (i.e., both posted in and borrowed) are efficiently used. This results in a conservative estimate of net interest income pickup in the optimization output. In general, (because of the nature of discrete optimization) not all resulting points (portfolios) on the lattice will be perfectly optimal given a constrained runtime, although it is very likely that they will still be practical, economically beneficial portfolios.

In one particular embodiment of the present invention, the primary displays within the GUI include: (a) portfolio selection grid; (b) proposed substitutions list; (c) existing & proposed repo trades; (d) comprehensive listing of target collateral portfolio.

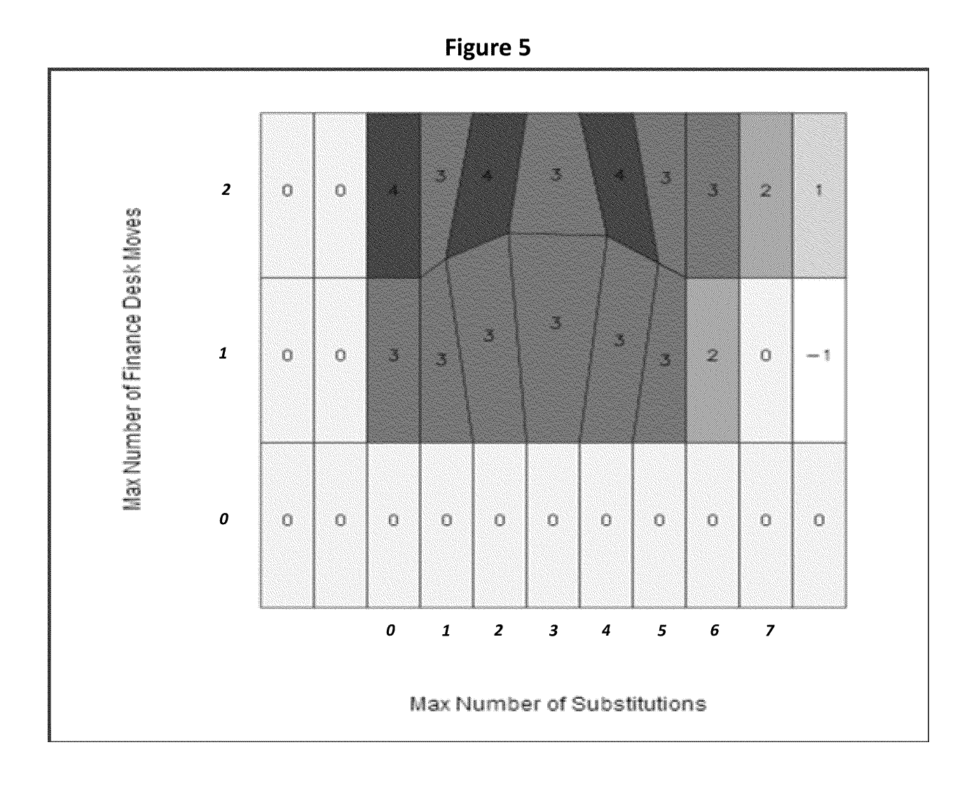

For example, FIG. 5 shows an exemplary output display of a collateral optimization run in accordance with an embodiment of the present invention. In this example, operational constraints allow a maximum of 7 substitutions and a maximum of 5 finance desk moves. The resulting display is a grid (shown partially in FIG. 5) with the number of substitutions as the horizontal axis and the number of finance desk moves as vertical axis, where the collateral portfolio return (for each combination of allowed number of substitutions and allowed number of finance desk moves) is shown with highlighted values (in units of one million dollars). In addition, a list of possible collateral operations such as substitutions and finance desk moves may be listed with detailed information such as CSA, counter party, optimizer allocation, existing allocation, collateral type, International Securities Identification Number (ISIN), source of ISIN, substitution type, detailed action, custody ID, repo amount, and so on.

The solution from the Solver 312 may also be used by the module 314 to generate reports such as rankings of collateral operations. According to some embodiments of the present invention, a once-per-week optimization run may be executed over a bank's entire portfolio, constrained by the number of collateral substitutions and by the number of repo/reverse-repo trades (for practicality).

A Daily Report Generation module 316 may further provide specific instructions to a group of CSRs (or a technology system) to execute the collateral adjustment and optimization solutions. For example, according to one embodiment, a daily report may be generated and distributed to the bank's collateral operations group and client service representatives which will suggest the optimal collateral to post/pullback in order to fulfill daily collateral requirements.

According to another embodiment, the daily report may predict the upcoming day's collateral movements and provide a ranked list of assets to be posted/recalled for each counterparty during these moves. The logic driving these suggestions attempts to maximize our long-term net interest income, taking into consideration (in order):
(1) Whether the overall (weekly) portfolio optimization run has suggested a substitution for the specified CSA. Any substitutions listed in the portfolio optimization take precedence over other collateral moves.
(2) The return rate of each piece of eligible collateral. A collateral pullback may attempt to recall the asset with the lowest rate of return, and a posting may try to allocate out the asset with the highest net return for the bank.
(3) The expected amount of collateral to be moved for the given CSA, relative to the size of each piece of re-hypothecatable inventory (in order to minimize the number of collateral movements). Pieces of collateral inventory which are close to the call amount are preferred, since they result in fewer collateral moves and will also prevent “fragmenting” of the collateral inventory.
(4) The number of times a particular asset has already been re-hypothecated (in order to reduce the risk of the original pledgor calling back collateral which has been re-hypothecated to a large number of clients).

The above-described techniques for collateral management and optimization may be best suited for scenarios where there are no relatively large fluctuations in the market and therefore day-to-day adjustments to a bank's collateral portfolio are not expected to require drastic measures. In a more volatile market environment (e.g., with a macroeconomic event), it may be desirable to anticipate market movements and be prepared for resulting collateral operations.

FIG. 6 shows a flowchart illustrating another exemplary method for managing and adjusting a portfolio of collateral assets according to one embodiment of the invention.

In Step 602, one or more market movement(s) may be predicted and/or the uncertainty of market movements may be modeled. For example, the bank's investment analysts may use quantitative tools and/or empirical or historical data to anticipate potential changes in certain market price parameters which may be the result of such events as earnings releases, merger or acquisition announcements, regulatory news, revision in credit ratings, and so on. Alternatively or additionally, the range of changes in the market price parameters may be set forth based on one or more mathematical models. According to one embodiment of the present invention, either a single market movement or a range of movements may be anticipated. For example, if an important piece of economic data to be announced the next day is expected to move a benchmark up to 10% in either direction, the collateral management or optimization system may be used to anticipate movements in the −10% to +10% range. In some embodiments, the anticipated movements may be assigned probabilities to indicate the respective likelihood of occurrence.

In Step 604, the bank's collateral posting needs, as a result of the market movement(s) predicted and/or modeled in Step 602, may be predicted and/or the uncertainty of the bank's collateral posting needs may be modeled. This predictions and/or modeled uncertainties may be based on historical data. For instance, the predicted change in MTM values of the bank's derivative trade positions may require a significant amount of additional collateral assets to be posted. Alternatively or simultaneously, the bank may expect to receive additional postings or pull-backs of collateral assets by one or more counterparties.

In Step 606, each relevant counterparty's behavior regarding its collateral postings may also be predicted and/or the uncertainty of such behavior may be modeled, based on the anticipated market movement(s) as well as historical data concerning the counterparty. For example, if a counterparty has previously (and perhaps consistently) reacted to calls by posting additional collateral with a certain type of assets, such information may be used to predict the amount and type of assets to receive from this counterparty, or to inform the certainty or uncertainty of this counterparty's behavior, in the event of the anticipated market movement(s). The counterparty's pullbacks or substitutions may be similarly predicted or modeled.

Then, in Step 608, the collateral optimization algorithm may be run based at least in part on the above predictions and/or modeling. In other words, as compared to the collateral optimization process described earlier, at least some of the input data may be replaced with predicted values rather than actual ones or according to corresponding probability models.

In Step 610, once the collateral optimization algorithm has identified the desired adjustments to the bank's collateral portfolio, the bank may proactively prepare for and/or execute the required collateral operations. For example, to the extent additional assets are expected to be needed but not currently available, preparations or arrangements may be made to borrow assets. The need for assets may be offset by expected postings of collateral from counterparties, taking into account both the amount and composition of those expected postings. Where a range of market movements are contemplated, the collateral optimization algorithm may account for each possible movement and its probability so as to generate optimal recommendations that respond to the whole range of market movements.

Other embodiments and uses of this invention will be apparent to those having ordinary skill in the art upon consideration of the specification and practice of the invention disclosed herein. The specification and examples given should be considered exemplary only, and it is contemplated that the appended claims will cover any other such embodiments or modifications as fall within the true scope of the invention.

For example, while the current solution is being applied to a specific trading desk Discount Central Utility and mainly for collateral postings and substitutions, the valuation and modeling in accordance with the disclosed embodiments can similarly be applied to Treasury Services, in which collateral optimization could be implemented to improve the management of institutional clients' portfolios. Such an extension may require additional scalability of the solution, for example, to accommodate a larger number of portfolios and/or faster compute time turnaround, which can be addressed by leveraging distributed compute-and-store frameworks, such as Hadoop or Grid Compute, as well as multi-threaded approaches for solving single programs that leverage message passing techniques.

For another example, The optimization of a collateral portfolio could be performed for postings only, for substitutions only, or for both. And, the optimization could be on a per-CSA basis or on a global basis (i.e., across a number of CSAs). Although the linear program runs on a weekly basis according to one embodiment, with more computing power, it could be run more frequently such as on a daily basis or around the clock.

In a specific application, the optimization mechanism may be applied to compute optimal tactical allocation of collateral when it is intended to eliminate the bank's exposure to a specific asset type (e.g., all corporate bonds, all treasuries) across all eligible CSAs. This can be achieved by using the same linear discrete program formulation and modifying the input valuation metrics for distinct asset types of interest. In addition, constraints on substitutions and finance desk moves may be removed if the number of CSAs eligible is substantially smaller than the full collateral portfolio and/or if the bank considers the cost of performing them negligible relative to the economic benefits obtained from making the new allocations.

The various embodiments and features of the presently disclosed invention may be used in any combination, as the combination of these embodiments and features are well within the scope of the invention. While the foregoing description includes many details and specificities, it is to be understood that these have been included for purposes of explanation only, and are not to be interpreted as limitations of the present invention. It will be apparent to those skilled in the art that other modifications to the embodiments described herein can be made without departing from the spirit and scope of the invention. Accordingly, such modifications are considered within the scope of the invention as intended to be encompassed by the following claims and their legal equivalents.

What is claimed is:

1. A computer-implemented method for collateral management, the method comprising:
storing, on at least one computer-readable storage medium, data associated with a portfolio of collateral assets posted in connection with a plurality of contracts, said data further including collateral requirements for each of the plurality of contracts;
storing, on the at least one computer-readable storage medium, valuation data associated with a plurality of assets available for collateral postings or substitutions;
establishing, by at least one computer processor, a linear discrete function of a quantified financial return from one or more hypothetical postings and/or substitutions in said portfolio of collateral assets, the one or more hypothetical postings and/or substitutions being based on said valuation data and complying with said collateral requirements for each of said plurality of contracts;
generating, by the at least one computer processor, a list of collateral operations with said plurality of available assets, by resolving, within at least one operational constraint, said linear discrete function to maximize or increase said quantified financial return; and
outputting said list of collateral operations as instructions, for a human operator or a computer system, to adjust said portfolio of collateral assets.

2. The computer-implemented method of claim 1, further comprising:
parsing said plurality of contracts to identify said collateral requirements.

3. The computer-implemented method of claim 2, further comprising:
segmenting, by the at least one computer processor, each of said plurality of contracts.

4. The computer-implemented method of claim 1, wherein said one or more hypothetical postings and/or substitutions comprise collateral allocation and/or re-allocation options generated by the at least one computer processor prior to the establishing of said linear discrete function.

5. The computer-implemented method of claim 1, further comprising:
ranking said generated list of collateral operations based on an amount of an expected financial return from each of the collateral operations.

6. The computer-implemented method of claim 1, wherein said collateral eligibility parameters specify one or more types of assets that are permitted as collateral pursuant to said each of said plurality of contracts.

7. The computer-implemented method of claim 1, wherein said collateral requirements further specify a minimum size of an asset and a total number of distinct asset pieces that are permitted as collateral pursuant to said each of said plurality of contracts.

8. The computer-implemented method of claim 1, wherein said plurality of contracts comprise Credit Support Annex (CSA) agreements.

9. The computer-implemented method of claim 1, wherein said linear discrete function calculates a total value of said quantified financial return from each of said one or more hypothetical postings and/or substitutions.

10. The computer-implemented method of claim 1, wherein said at least one operational constraint is selected from a group consisting of: (a) a maximum number of collateral substitutions in connection with each contract; (b) a maximum number of finance desk moves across said plurality of contracts; and (c) a maximum total number of collateral substitutions and finance desk moves across said plurality of contracts.

11. The computer-implemented method of claim 1, further comprising:
receiving an input of market data associated with said plurality of contracts;
determining a required adjustment to said portfolio of collateral assets; and
causing said list of collateral operations to lead to said required adjustment.

12. The computer-implemented method of claim 1, further comprising:
predicting a change in market data associated with said plurality of contracts;
predicting a required adjustment to said portfolio of collateral assets; and
causing said list of collateral operations to lead to said required adjustment.

13. The computer-implemented method of claim 12, wherein the step of predicting further comprises predicting at least one counterparty's collateral operation behavior in light of the predicted change in the market data.

14. The computer-implemented method of claim 1, further comprising:
modeling a first uncertainty of changes in market data associated with said plurality of contracts;
modeling a second uncertainty of required adjustments to said portfolio of collateral assets based on the modeling of said first uncertainty; and
determining said list of collateral operations based on the modeling of said second uncertainty.

15. A computer-implemented system for collateral management, the system comprising at least one computer-readable storage medium and at least one computer processor for implementing:
a data management module that manages data associated with a portfolio of collateral assets posted in connection with a plurality of contracts and valuation data associated with a plurality of assets available for collateral postings or substitutions;
a contract parsing module that identifies collateral requirements for each of the plurality of contracts;
an optimization formulation module that establishes a linear discrete function of a quantified financial return from one or more hypothetical postings and/or substitutions in said portfolio of collateral assets, the one or more hypothetical postings and/or substitutions being based on said valuation data and complying with said collateral requirements for each of said plurality of contracts;
a solution module that generates a list of collateral operations with said plurality of available assets, by resolving, within at least one operational constraint, said linear discrete function to maximize or increase said quantified financial return; and
an output module that outputs said list of collateral operations as instructions, for a human operator or a computer system, to adjust said portfolio of collateral assets.

16. The computer-implemented system of claim 15, further adapted to segment each of said plurality of contracts.

17. The computer-implemented system of claim 15, further comprising:
an allocation option module that generates collateral allocation and/or re-allocation options generated prior to establishing said linear discrete function.

18. The computer-implemented system of claim 15, further adapted to:
rank said generated list of collateral operations based on an amount of an expected financial return from each of the collateral operations.

19. The computer-implemented system of claim 15, wherein said collateral eligibility parameters specify one or more types of assets that are permitted as collateral pursuant to said each of said plurality of contracts.

20. The computer-implemented system of claim 15, wherein said collateral requirements further specify a minimum size of an asset and a total number of distinct asset pieces that are permitted as collateral pursuant to said each of said plurality of contracts.

21. The computer-implemented system of claim 15, wherein said plurality of contracts comprise Credit Support Annex (CSA) agreements.

22. The computer-implemented system of claim 15, wherein said linear discrete function calculates a total value of said quantified financial return from each of said one or more hypothetical postings and/or substitutions.

23. The computer-implemented system of claim 15, wherein said at least one operational constraint is selected from a group consisting of: (a) a maximum number of collateral substitutions in connection with each contract; (b) a maximum number of finance desk moves across said plurality of contracts; and (c) a maximum total number of collateral substitutions and finance desk moves across said plurality of contracts.

24. The computer-implemented system of claim 15, further adapted to:
receive an input of market data associated with said plurality of contracts;
determine a required adjustment to said portfolio of collateral assets; and
cause said list of collateral operations to lead to said required adjustment.

25. The computer-implemented method of claim 15, further adapted to:
predict a change in market data associated with said plurality of contracts;
predict a required adjustment to said portfolio of collateral assets; and
cause said list of collateral operations to lead to said required adjustment.

26. The computer-implemented system of claim 25, further adapted to:
predict at least one counterparty's collateral operation behavior in light of the predicted change in the market data.

27. The computer-implemented system of claim 15, further adapted to:
model a first uncertainty of changes in market data associated with said plurality of contracts;
model a second uncertainty of required adjustments to said portfolio of collateral assets based on the modeling of said first uncertainty; and
determine said list of collateral operations based on the modeling of said second uncertainty.
